(19) United States
(12) Patent Application Publication
(10) Pub. No.: US 2024/0283178 A1
(43) Pub. Date: Aug. 22, 2024

(54) Plug-in Connector, Plug-in Connector Arrangement and Method For Producing The Plug-in Connector

(71) Applicant: ERNI International AG, Schaffhausen (CH)

(72) Inventor: Kai-Rene Semilia, Bad Ditzenbach (DE)

(73) Assignee: ERNI International AG, Schaffhausen (CH)

(21) Appl. No.: 18/654,202

(22) Filed: May 3, 2024

Related U.S. Application Data
(63) Continuation of application No. PCT/EP2022/080565, filed on Nov. 2, 2022.

(30) Foreign Application Priority Data
Nov. 5, 2021 (DE) 10 2021 128 888.6

(51) Int. Cl. H01R 12/77; H01R 43/24

(52) U.S. Cl. CPC H01R 12/778; H01R 43/24

(57) ABSTRACT

A plug-in connector includes a first housing part having a plug-in contact element and a plurality of blades electrically connected to the plug-in contact element and a second housing part having a receiving region with a receiving direction. The second housing part has a first pair of spring elements arranged resiliently in the receiving region on a first side of the receiving direction and a second pair of spring elements arranged resiliently in the receiving region on a second side of the receiving direction.

### CROSS-REFERENCE TO RELATED APPLICATIONS

This application is a continuation of PCT International Application No. PCT/EP2022/080565, filed on Nov. 2, 2022, which claims priority under 35 U.S.C. § 119 to German Patent Application No. 102021128888.6, filed on Nov. 5, 2021.

### FIELD OF THE INVENTION

The present invention relates to a plug-in connector for a flexible conductor film. Furthermore, the present invention relates to a method for producing the plug-in connector and a plug-in connector arrangement comprising the plug-in connector.

### BACKGROUND

Flexible conductor films with film-insulated conductors are currently used in a wide variety of fields in entertainment and consumer electronics, as well as in vehicle construction. Conductor films are used in particular where a very flexible conductor structure is required with the lowest possible weight and limited space conditions. Flexible conductor films allow an orderly parallel guide of a plurality of separate strip conductors, wherein even larger bends are possible and thus parts can be electrically conductively connected to each other, which are arranged in a very limited installation space. In particular in vehicle construction, such conductor films must also be able to withstand greater mechanical effects, such as vibrations.

The contacting of the individual film-insulated conductors is of particular importance. Particularly in vehicle construction, this contacting must be secure and resistant to external mechanical influences, but also to temperature influences and environmental influences of all kinds.

DE 10 2015 100 401 B4 describes a plug-in connector for flexible conductor films with film-insulated conductors with a plug-in connector housing in which at least one plug-in contact element is arranged. In a connection region, blades electrically conductively connected to the at least one plug-in contact element can penetrate and fix at least one film-insulated conductor, establishing an electrical contact. The plug-in connector housing comprises two housing parts that can be pushed into one another. The first housing part holds the blades and the at least one plug-in contact element that is electrically conductively connected to them. The second housing part receives and holds the flexible conductor film. Furthermore, the second housing part has at least one blade holder adapted to the blades, the boundary surfaces of which are configured such that at least some of the blades are bent in the direction of the film-insulated conductors when the two housing parts are pushed into one another. By bending the blades, a pressure is exerted on the contact surface between the blades and the conductor film, so that the electrical contact surface increases. At the same time, the blades are held under a certain amount of tension in the plug-in connector housing. In this way, good electrical and gas-tight contact can be achieved in the plug-in connector.

In order to receive the flexible conductor film in the second housing part, it is inserted into the plug-in connector through a receiving opening. However, in this case, conductor films have high tolerances, due to which they are not always held centrally in the connector housing. If the blades are moved towards an incorrectly held conductor film in order to cut into it, they may cut into the edge region of a conductor. While one part of the blades then still makes electrical contact with the conductor, another part merely extends through the insulation material of the conductor film. This impairs electrical contacting between the conductor and the plug-in contact element.

DE 199 20 981 A1 describes an electrical connector. This has an insulator with an opening section for receiving a connecting part at a predetermined position above a plurality of contacts. A pressing part is rotatably supported by the insulator. A locking assembly is used to lock the pressing part to the insulator only when the locking part is correctly located at the predetermined position. A detection assembly detects the incorrect positioning of the locking part. The locking assembly has a locking section formed on the insulator and an engaging projection formed on the pressing part to be engaged with the locking section. The detection assembly has a pair of locking arms formed on the insulator and a detection protrusion formed on the pressing part. When the connecting part is partially inserted between the locking arms, the locking arms are pressed outwards and deformed, thereby hindering the rotation of the pressing part.

DE 11 2013 003 215 T5 describes a flexible integrated multi-wire plug-in connector. This comprises a pair of engaging hooks, each of which is formed on both end faces of a mounting surface in the width direction and engages in a pair of engaging holes, each of which is drilled on both end faces of a terminal part in the width direction.

U.S. Pat. No. 4,577,920 discloses a one-piece metal element for guiding a cable into a shielded connector housing having a cable holding base. Cable locators protrude upwardly from the cable holding base in order to arrange between them a range of insulated conductors and a cable sheath.

There is a need for a plug-in connector for a flexible conductor film with film-insulated conductors, in which the conductor film can be positioned with such precision that it is ensured that all blades of the plug-in connector always cut completely through.

### SUMMARY

A plug-in connector includes a first housing part having a plug-in contact element and a plurality of blades electrically connected to the plug-in contact element and a second housing part having a receiving region with a receiving direction. The second housing part has a first pair of spring elements arranged resiliently in the receiving region on a first side of the receiving direction and a second pair of spring elements arranged resiliently in the receiving region on a second side of the receiving direction.

### BRIEF DESCRIPTION OF THE DRAWINGS

Embodiments of the invention are shown in the drawings and are explained in more detail in the following description.

FIG. 1a shows components of a plug-in connector arrangement according to one embodiment of the invention in a first assembly step in an isometric view;

FIG. 1b shows components of a plug-in connector arrangement according to one embodiment of the invention in a first assembly step in a sectional isometric view;

FIG. 1c shows components of a plug-in connector arrangement according to one embodiment of the invention in a first assembly step in a top view;

FIG. 1d shows components of a plug-in connector arrangement according to one embodiment of the invention in a first assembly step in an isometric sectional view;

FIG. 2 shows a top view of a spring element of a plug-in connector according to one embodiment of the invention;

FIG. 3a shows a plug-in connector arrangement according to one embodiment of the invention in a second assembly step in an isometric view;

FIG. 3b shows a plug-in connector arrangement according to one embodiment of the invention in a second assembly step in a sectional isometric view;

FIG. 3c shows a plug-in connector arrangement according to one embodiment of the invention in a second assembly step in a top view; and

FIG. 3d shows a plug-in connector arrangement according to one embodiment of the invention in a second assembly step in an isometric sectional view.

### DETAILED DESCRIPTION OF THE EMBODIMENT(S)

In the following, the invention will be described in greater detail and in an exemplary manner using embodiments and with reference to the drawings. The described embodiments are only possible configurations in which, however, the individual features as described herein can be provided independently of one another or can be omitted.

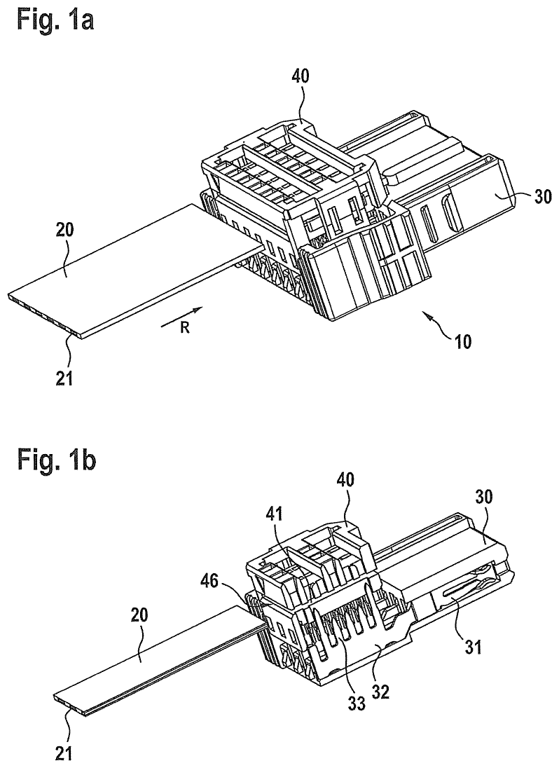

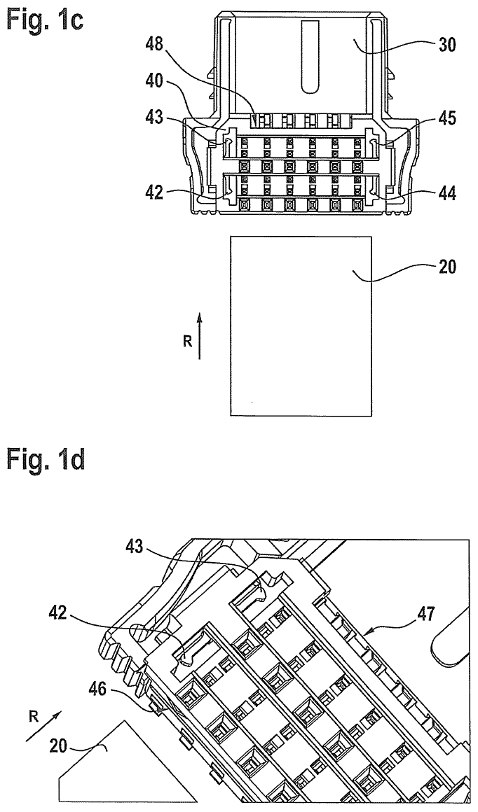

FIGS. 1a to 1d show a first assembly step of a plug-in connector arrangement according to one embodiment of the invention. A plug-in connector 10 and a flat flexible conductor film 20 with film-insulated conductors 21 are provided. The plug-in connector 10 has a first housing part 30 and a second housing part 40. A plurality of plug-in contact elements 31 are arranged in the housing part 30. Each plug-in contact element 31 is electrically conductively connected to five blades 33 via a blade strip 32, as shown in FIG. 1b. The second housing part 40 has a receiving region 41 for the conductor film 20. The receiving region 41 is widened in a funnel shape towards the outside of the plug-in connector 10 in order to facilitate insertion of the conductor film 20.

The conductor film 20 can be inserted into the receiving region 41 along a receiving direction R. The receiving direction R is here understood to be the direction in which the conductor film 20 can be pushed from outside the plug-in connector 10 into the receiving region 41 of the plug-in connector 10. The receiving region 41 is provided for a conductor film 20 to be pushed into it along the receiving direction R with its front side, while its rear side remains outside the plug-in connector 10.

As shown in FIGS. 1c and 1d, two spring elements 42, 43 are arranged along the receiving direction R on the left-hand side of the receiving region 41. Two further spring elements 44, 45 are arranged along the receiving direction R on the right-hand side of the receiving region 41. The spring elements 42, 43 are spring-biased orthogonally to the receiving direction R.

The insertion of the conductor film 20 into the receiving region 41 takes place through a slot-shaped receiving opening 46. The receiving region 41 ends at a stop 47, against which the conductor film 20 abuts with its front side when it is pushed into the receiving region 41 through the receiving opening 46. The second housing part 40 has a slot-shaped opening 48 on its upper side, through which the stop 47 is visible. The opening 48 is configured in particular as a slot that runs orthogonally to the receiving direction R. Its length corresponds in an embodiment to a width of the receiving region 41.

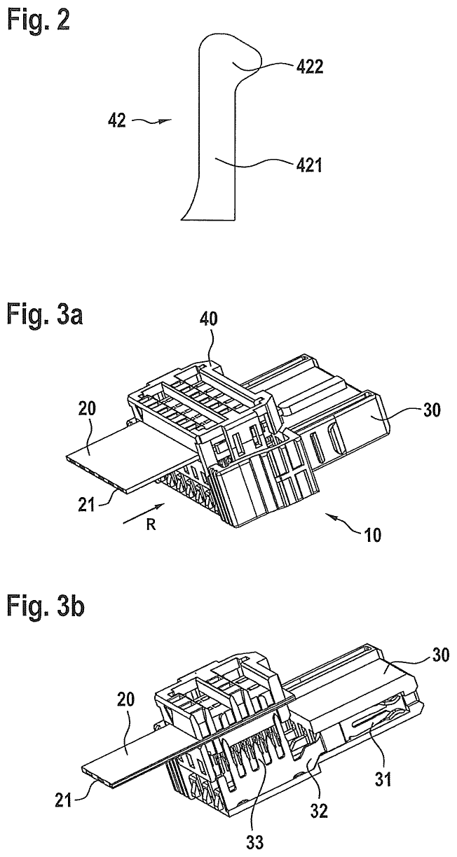

FIG. 2 shows one of the spring elements 42 but is representative of the components of all the spring elements 42-45. The spring element 42 has a spring arm 421, which is arranged essentially parallel to the receiving direction R in the receiving region 41. By essentially parallel, it is understood in particular that a longitudinal axis of the spring arm 421 forms an angle of at most 10 degrees with the receiving direction R.

A positioning element 422 projects from one end of the spring arm 421 orthogonally to the receiving direction in the direction of the conductor film 20 into the receiving region 41. The end of the spring arm 421, which is opposite the positioning element 422, is connected to the base body of the second housing part 40. As a result, the spring element 42 is spring-biased. When the conductor film 20 is inserted into the receiving region 41, the spring element 42 contacts the conductor film 20 at a defined position by the positioning element 422. The spring arm 421 is deflected relative to its longitudinal axis, causing a spring force to act on the conductor film 20.

In an embodiment, all elements of the second housing part 40, including the spring arms 421 and positioning elements 422 of all spring elements 42-45, are formed in one piece from a plastic material.

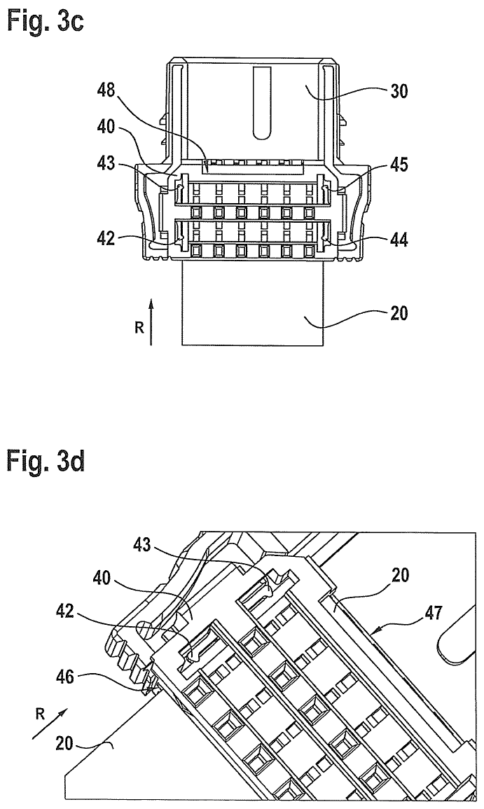

A second assembly step of the plug-in connector arrangement is shown in FIGS. 3a to 3d. The conductor film 20 has been pushed into the receiving region 41 of the plug-in connector 10 until it abuts the stop 47, so that the conductor film 20 is supported in the receiving region 41. Abutting of the conductor film 20 against the stop 47 can be checked visually through the opening 48, shown in FIG. 3c, through which the abutment of the conductor film with the stop 47 can be seen.

In the state shown in FIGS. 3a to 3d, all spring elements 42 to 45 are abutting the sides of the conductor film 20 at one point each. In this process, the positioning elements 422 of the first two spring elements 42, 43 press against the left side of the conductor film 20 and the positioning elements of the other spring elements 44, 45 press against the right side of the conductor film 20. Before the conductor film 20 was inserted, the free area in the receiving region 41 spanned by the positioning elements was slightly narrower than the conductor film 20. When it was inserted into the receiving region 41, the spring arms 421 of all the spring elements 42-45 are deformed in order to move the positioning elements 422 away from the conductor film 20 and in this way enable them to be inserted into the receiving region 41.

All spring elements 42-45 press against the conductor film 20 by their spring force and position it in the center of the receiving region 41. As a result, each strip conductor 21 is positioned exactly over a blade strip 32. In embodiments in which the plug-in connector 10 has several spring elements 42-45, all spring elements 42-45 may be equally spring-biased so that pressure is exerted evenly on the conductor film 20.

The spring force acts orthogonally to the receiving direction R. This allows the conductor film 20 to be positioned orthogonally to the receiving direction R at a desired position. Tolerances between the width of the conductor film 20 and the width of the receiving region 41 are thereby unproblematic. The receiving region 41 can therefore be configured with such a width that the conductor film 20 can be easily inserted into it. It can also be adapted for conductor films 20 of different widths, provided that the position of the conductors 21 on the conductor film 20 is identical for all conductor films 20.

By exerting pressure on the conductor film 20 at two different positions on each side, it is not only centered in the receiving region 41, but the longitudinal axis of the conductor film 20 is also prevented from being twisted against the receiving direction R. In addition, two spring elements 42-45 on each side allow redundant contacting of the conductor film 20, which means that centering is still possible even if one of the spring elements 42-45 is damaged. The stop 47 and the spring elements 42-45 allow exact positioning of the conductor film 20 both along the receiving direction R and orthogonally to the receiving direction R.g

If, in a third assembly step not shown, the two housing parts 30, 40 are moved towards each other or pushed into one another so that the blades 33 cut through the conductor film 20, this ensures that each blade 33 cuts through the center of one of the strip conductors 21.

The production of the two housing parts 30, 40 of the plug-in connector 10 can be carried out using an injection molding process. For this purpose, a molten thermoplastic material is injected into a mold. When casting the second housing part 40, the gating is positioned such that all spring elements 42-45 are completely formed from the casting compound at the start of filling the mold before the remaining areas of the second housing part 40 are formed.

This configuration of the plug-in connector 10 allows the conductor film 20 to first be inserted into the receiving region 41 of the second housing part 40 and then the housing parts 30, 40 to be pushed further into one another so that the blades 33 are moved into the receiving region 41 and cut through the conductor film 20. In this case, the spring elements 42-45 in the receiving region 41 allow the conductor film 20 to be positioned in the receiving region 41 such that each conductor 21 of the conductor film 20 comes to rest above several blades 33 that are connected to the same plug-in contact element 31, wherein the blades 33 are each positioned centrally on the conductor 21. This ensures that the blades 33 only cut through the conductor 21 and do not cut into an insulation material at the edge of the conductor 21.

In a second aspect, the invention relates to a method for producing the plug-in connector 10. In the method, the second housing part 40, which comprises the spring elements 42-25, is produced in a mold by a casting process. The casting process is, in particular, an injection molding process. In the casting process, the mold is filled with a casting compound, in particular with a plastic melt. In this process, filling takes place such that the spring elements 42-45 are not filled at the end of filling the mold. By filling the part of the mold used to form the spring element 42-45 at an early stage of the casting process and gating at a different position of the housing part 40, complete and uniform filling of this part of the mold is ensured. As a result, tolerances in the form of a spring element 42-45 due to uneven filling at this point can be ruled out. Such tolerances should be avoided because an error-free form and positioning of the spring elements 42-45 are important for precise positioning of the conductor film 20 in the plug-in connector 10.

What is claimed is:

1. A plug-in connector, comprising:
a first housing part having a plug-in contact element and a plurality of blades electrically connected to the plug-in contact element; and
a second housing part having a receiving region with a receiving direction, the second housing part has a first pair of spring elements arranged resiliently in the receiving region on a first side of the receiving direction and a second pair of spring elements arranged resiliently in the receiving region on a second side of the receiving direction.

2. The plug-in connector of claim 1, wherein the first housing part and the second housing part are pushed into one another.

3. The plug-in connector of claim 1, wherein a conductor film having a plurality of film-insulated conductors is received in the receiving region along the receiving direction.

4. The plug-in connector of claim 3, wherein the receiving region has a stop for the conductor film opposite a receiving opening for the conductor film.

5. The plug-in connector of claim 4, wherein the second housing part has an opening through which the stop is visible.

6. The plug-in connector of claim 1, wherein each of the spring elements in the first pair of spring elements and the second pair of spring elements has a spring arm arranged essentially parallel to the receiving direction.

7. The plug-in connector of claim 6, wherein each of the spring elements in the first pair of spring elements and the second pair of spring elements has a positioning element projecting from the spring arm orthogonally to the receiving direction into the receiving region.

8. The plug-in connector of claim 7, wherein the spring arm and the positioning element are formed in a single piece.

9. The plug-in connector of claim 7, wherein the spring arm and the positioning element are formed of a plastic material.

10. The plug-in connector of claim 1, wherein the first pair of spring elements and the second pair of spring elements are formed in a single piece with the second housing part.

11. A method for producing a plug-in connector, comprising:
providing a first housing part having a plug-in contact element and a plurality of blades electrically connected to the plug-in contact element; and
casting a second housing part in a mold, the second housing part having a receiving region with a receiving direction, a first pair of spring elements arranged resiliently in the receiving region on a first side of the receiving direction, and a second pair of spring elements arranged resiliently in the receiving region on a second side of the receiving direction.

12. The method of claim 11, wherein the first pair of spring elements and the second pair of spring elements are not formed at an end of a filling of the mold with a casting compound.

13. A plug-in connector arrangement, comprising:
a plug-in connector including a first housing part having a plug-in contact element and a plurality of blades electrically connected to the plug-in contact element and a second housing part having a receiving region with a receiving direction, the second housing part has a first pair of spring elements arranged resiliently in the receiving region on a first side of the receiving direction and a second pair of spring elements arranged resiliently in the receiving region on a second side of the receiving direction.

14. The plug-in connector arrangement of claim 13, further comprising a conductor film having a plurality of film-insulated conductors, the conductor film is insertable into the receiving region along the receiving direction.

15. The plug-in connector arrangement of claim 14, wherein at least one of the first pair of spring elements presses against a first side of the conductor film and at least one of the second pair of spring elements presses against a second side of the conductor film opposite the first side.

16. The plug-in connector arrangement of claim 15, wherein the conductor film is centered in the receiving region by the first pair of the spring elements and the second pair of spring elements.

17. The plug-in connector arrangement of claim 14, wherein the first housing part and the second housing part are pushed into one another to electrically connect the plug-in contact element with the film-insulated conductors.

18. The plug-in connector arrangement of claim 17, wherein all of the blades electrically contact one of the film-insulated conductors.

19. The plug-in connector arrangement of claim 14, wherein the conductor film is guiding through a receiving opening into the receiving region and hits a stop opposite the receiving opening.
